(19) United States
(12) Patent Application Publication
(10) Pub. No.: US 2009/0088903 A1
(43) Pub. Date: Apr. 2, 2009

(54) CONTROL STRUCTURE FOR SETTING A SET POINT OF A TEMPERATURE OF A SPACE

(75) Inventors: Hans Joergen Klein, Soenderborg (DK); Hans-Erik Fogh, Broager (DK)

Correspondence Address: MCCORMICK, PAULDING & HUBER LLP, CITY PLACE II, 185 ASYLUM STREET, HARTFORD, CT, 06103, US

(73) Assignee: Danfoss A/S, Norborg (DK)

(21) Appl. No.: 12/280,189

(22) PCT Filed: Feb. 27, 2007
(86) PCT No.: PCT/DK2007/000090

§ 371 Date: Nov. 26, 2008

(30) Foreign Application Priority Data
Feb. 28, 2006 (DK) PA 2006 00281

(51) Int. Cl. G05B 15/00

(52) U.S. Cl. 700/278

(57) ABSTRACT

The invention provides a system adapted to modify a temperature of a space based on a user selected set-point for the temperature of the space, e.g. a refrigerator, a sauna or a regular building with a HVAC system. The set-point is selected via a control structure which includes a handle being movable relative to a base. In order to simplify the installation and the structure of the space, and further to enable better thermal isolation of the space, the handle comprises a temperature sensing structure. Accordingly, no additional installation work, cabling, and penetration of the wall into the space are necessary for installing separate temperature sensing devices.

### CROSS REFERENCE TO RELATED APPLICATIONS

This application is entitled to the benefit of and incorporates by reference essential subject matter disclosed in International Patent Application No. PCT/DK2007/000090 filed on Feb. 27, 2007 and Danish Patent Application No. PA 2006 00281 filed Feb. 28, 2006.

### TECHNICAL FIELD

The invention relates to a system adapted to modify a temperature of a space based on a user selected set-point for the temperature of the space. The set-point could e.g. be a desired temperature or a desired activity level of the temperature modifying structure. The system may e.g. form part of a refrigerator or it may form part of a sauna or any similar environment in which the temperature is modified. In particular, the system comprises: a climate modifying structure for modifying the temperature of the space, a temperature sensing structure for providing a temperature signal significant for the temperature of the space, a control structure comprising a base and a handle and being adapted for setting the set-point by movement of the handle relative to the base, and processing means arranged in communication with the control structure to receive a set point signal significant for the set-point, in communication with the temperature sensing structure to receive the temperature signal, and in communication with the climate modifying structure to control modification of the temperature based on the set point and the temperature signal.

### BACKGROUND OF THE INVENTION

Typically, the temperature of refrigerators, saunas and similar spaces in which the temperature is modified relative to the temperature of a surrounding space, is adjusted based on a set-point given by the user of the space. In the following, the invention will be explained in connection with a refrigerator, i.e. an environment in which the temperature is reduced by means of a compressor or similar temperature modifying structure. The invention may be applied in connection with an oven, a sauna, a regular HVAC system for heating or cooling of a building etc.

A refrigerator normally comprises in inliner i.e. a shell forming an inner surface of the refrigerated space. To reduce the exchange of thermal energy with a surrounding space, the inliner is encapsulated in an isolating foam material, and to protect the foam and to provide a nice exterior, the inliner and foam is encapsulated in an outliner which forms an outer surface of the refrigerator. The refrigerated space is cooled down by an evaporator which forms part of a loop which further comprises a compressor and a condenser located outside the refrigerated space. A control, e.g. located on the front of the refrigerator or located within the refrigerated space allows the user to specify a temperature or at least a cooling intensity of the refrigerator. The control is normally connected to a control unit which controls either the compressor or which controls the flow of compressed refrigerant into the evaporator. The control unit is further connected to a temperature sensor and calculates a difference between the desired temperature of the refrigerator and the actual temperature of the refrigerator. The measured temperature is a temperature of the evaporator or a temperature of the refrigerated chamber. Due to the desired thermal isolation, openings through the inliner is undesired, and due to the foam material, repairing and replacing of components inside the refrigerator, e.g. the temperature sensor, is difficult and often impairs the thermal isolation.

### BRIEF SUMMARY OF THE INVENTION

It is an object of the present invention to facilitate easier installation of controls for temperature modifying systems. Accordingly, the present invention in a first aspect provides a system wherein the temperature sensing structure is comprised in the handle.

Since the temperature sensing structure is comprised in the handle, the number of components which is to be installed and wired is reduced, the interior design can be simplified, and the thermal isolation may be improved since the inliner or similar inner surface of the environment is penetrated at fewer locations.

The base and the processing means may be located outside the space, and the handle may project through a wall which encapsulates the space and into the space. For that purpose, the control structure may preferably be provided with a flange which facilitate attachment to the wall, e.g. to an inliner of a refrigerator.

Often, the temperature of the space varies from a point located in the middle of the space towards the wall which encapsulates the space. In order to obtain a more exact measurement of the temperature of the space rather than the temperature of the wall, the flange may be provided in a material which has a thermal conductivity which is lower than the thermal conductivity of the wall. To further improve the measurement of the temperature, the temperature sensing structure may be located in a tip part of the handle which terminates the handle inside the space. Preferably, the length of the handle relative to the length of the temperature sensing structure provides a distance in a direction perpendicular to the wall between the wall and the temperature sensing structure.

The temperature sensing structure may comprise a sealed chamber with a fluid which is influenced by the temperature to expand or contract whereby a pressure signal is conducted from the sensing structure in a fluid conduit to the processing means. The temperature sensing structure may also be adapted to transmit an electrical signal, i.e. the structure may be of a kind known in the art, e.g. which changes an electrical resistance based on variations of the temperature. To simplify electrical connectivity between the control structure and the processing means and between the temperature sensing structure and the processing means, the base may form a common ground potential for the set-point signal and for the temperature signal and individual connecting terminals for the set-point signal and the temperature signal. The terminals may form elongated legs e.g. extending from the base in a direction which is opposite the direction in which the handle extends from the base, and the common ground may e.g. be provided in a surface portion of the body or by an additional elongated leg. The legs could be received directly into a printed circuit board which forms part of the processing means.

In one embodiment, the handle comprises a sensing portion which is more thermally conductive than the remaining part of the handle and which encapsulates the temperature sensing structure.

The processing means could be adapted to turn a compressor or an electrical oven, a fan or similar temperature modifying structure on or off based on a signal from the temperature sensing structure. In one simple embodiment, the processing means is constituted by an expansion valve which controls flow of compressed and condensed refrigerant into an evaporator. This valve could be in fluid communication with the expandable and contractable fluid in a sealed chamber of the temperature sensing structure, or the valve could be electrically operated.

In a second aspect, the invention provides a control structure for setting a set point of a temperature of a space in which the control structure is located or in which at least a portion of the control structure is located. The control structure comprises a base and a handle and is adapted for setting the set-point by movement of the handle relative to the base, characterised in that the handle comprises a temperature sensing structure for providing a temperature signal significant for a temperature of the space.

The structure may comprise an attachment structure for attaching the structure to a planar inliner of a refrigerator casing, e.g. so that the base is located on a first side of the attachment structure, and the handle projects from the base from an opposite, second, side of the attachment structure.

The handle may in particular be adapted for rotation around a centre axis which projects from the base. In one embodiment, the handle comprises a pin or bar with a small radial size and which projects from the base. The pin may be inserted into the space from outside via a narrow hole in the inliner. The base may then be fastened to an outer surface of the inliner, and subsequently, a knob with a radial size which is large relative to the radial size of the pin may be attached to the pin. In this embodiment, the temperature sensing structure may utilise a surface of the relatively large knob to transmit the temperature of the space to a sensing element located in the pin. Alternatively, the knob may contain the entire temperature sensing structure and connectors which engage with corresponding connectors of the pin to transfer the temperature signal to the pin. This embodiment facilitates easy replacement of the temperature sensing structure, allows the structure to be located inside the space at a distance from the wall, and makes use of no additional penetrations of the inliner than the one provided for the relatively small pin.

In an alternative embodiment, the base and the handle, including the temperature sensing structure is included in one electrical component which can be located inside the space and from which an electrical cable transmits the temperature signal and the set-point signal to the processing means which is located outside the space—i.e. the inliner is penetrated by a cable.

In yet another embodiment, the control structure is integrated with the processing means to form one electrical component which can be located inside the space. The component could be connected to the compressor or similar temperature modifying structure outside the space via a cable which penetrates the inliner, or the component could be connected to an electrically operated valve which controls flow of refrigerant into an evaporator.

In addition to the temperature sensing structure, the handle may further comprise illuminating means, e.g. adapted to project light through a portion of the handle or located on an outer surface of the handle. The illuminating means may e.g. comprise at least one Light Emitting Diode (LED) or a regular light bulb The illuminating means facilitates operation of the handle in poor light conditions, e.g. in a sauna or in a refrigerator. The illuminating means may be designed to indicate the selected set-point or to indicate the achieved temperature e.g. by varying intensity of the light or by varying colours of the light.

### BRIEF DESCRIPTION OF THE DRAWINGS

In the following, the invention will be described in further details with reference to the drawing in which:

FIG. 1 shows a cross-section of a refrigerator with a control structure according to the invention,

FIG. 2 shows a cross-section of the control structure,

FIGS. 3-4 show various embodiments of the control structure,

FIG. 5 shows an embodiment of the control structure embedded in a lamp which is located inside the refrigerator, and

FIG. 6 shows an enlarged view of the control structure shown in FIG. 5.

### DETAILED DESCRIPTION OF THE PREFERRED EMBODIMENTS

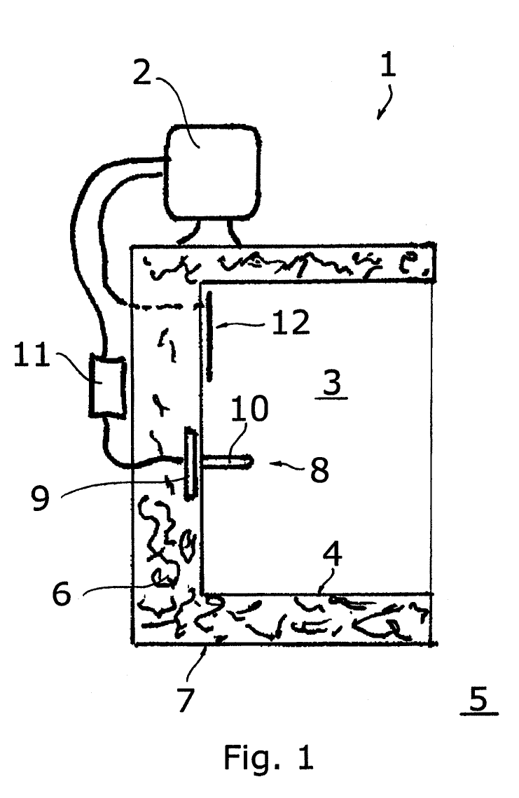

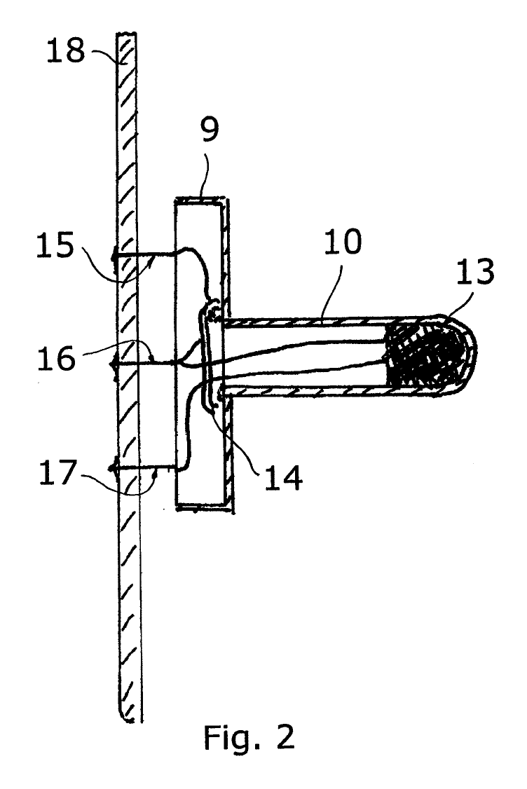

FIG. 1 shows a refrigerator 1 with a compressor 2 adapted to modify the temperature of the space 3, which is encapsulated by a wall formed by the inliner 4. To reduce thermal exchange with the ambient space 5, the inliner is encapsulated in a foam material 6, and to protect the foam and to provide a nice exterior surface, the foam is encapsulated in an outliner 7. A control structure 8 is located partly in the space and partly between the inliner and outliner. The control structure is shown in further details in FIG. 2 and comprises a base 9 and a handle 10. The control structure allows a user of the refrigerator to specify a temperature of the space or an activity level of the compressor by moving the handle relative to the base.

Again referring to FIG. 1, the refrigerator further comprises a processor 11 located outside the space and communicating with a temperature sensing structure, with the control structure and with the compressor and/or with a valve which controls the flow of compressed refrigerant from the compressor to the evaporator 12 located in the space.

The temperature sensing structure 13 is comprised in the handle, c.f. FIG. 2, and the handle is joined with the base in a structure 14 adapted to provide an electrical signal indicative of the position of the handle relative to the base, e.g. a potentiometer. The control structure comprises three oblong electrical conductive legs 15, 16, 17 one of which defines a common ground potential for the set-point signal and for the temperature signal, and the other two conducting the set-point signal and the temperature signal, respectively. In one embodiment, the legs are received directly in a printed circuit board 18 which forms part of the processing means.

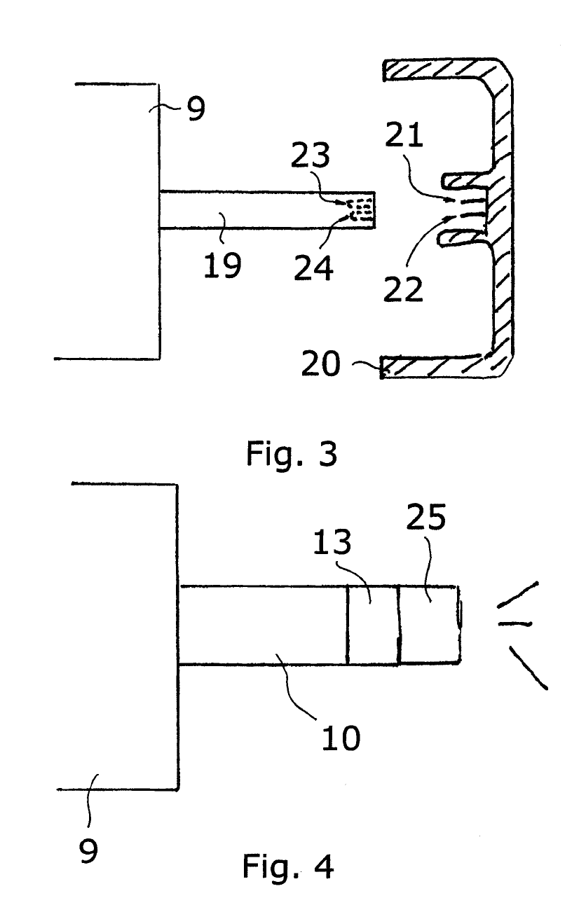

FIG. 3 shows an embodiment of the control structure wherein the handle comprises a pin 19 and a knob 20. The knob comprises the temperature sensing structure, and the temperature signal is transmitted via the connectors 21, 22 of the knob which engage corresponding connectors 23, 24 of the pin when the knob is attached to the pin.

FIG. 4 shows an embodiment of the control structure in which illuminating means 25 projects light through a portion of the handle. Illuminating means may also be combined with the embodiment shown in FIG. 3. In this case, the illuminating means may either be located in the pin to project light trough an opening or through a transparent area of the knob or the illuminating means could be located in the knob. If the illuminating means is located in the knob, further connectors are required between the pin and the knob.

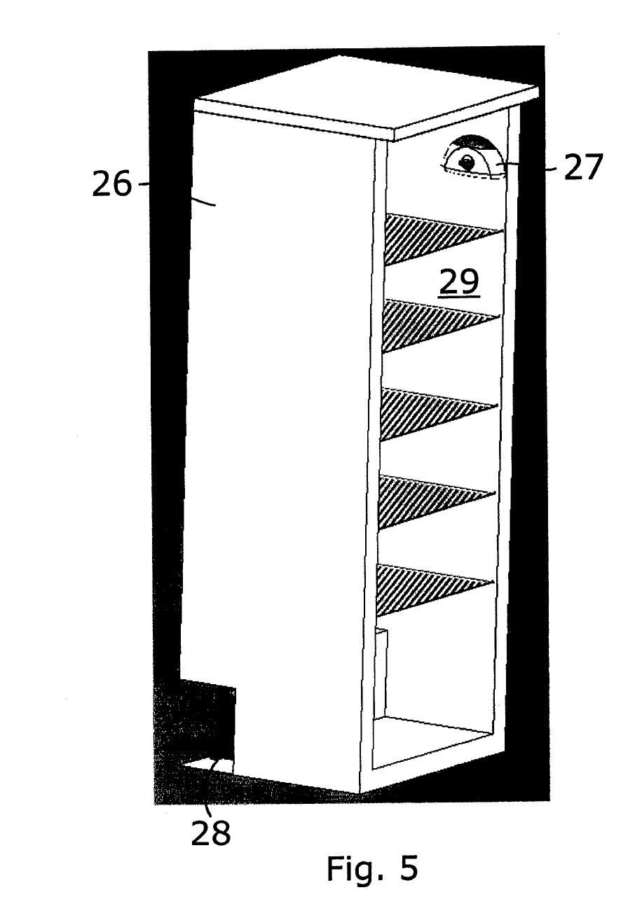

FIG. 5 shows a refrigerator 26 with a combined lamp and control structure unit 27. The unit further comprises processing means for providing control of the compressor 28 to which the unit is connected via an electrical connection (not shown). Contrary to the embodiment of FIG. 1, the control structure is located entirely inside the refrigerator, and the inliner 29 of the refrigerator is therefore penetrated by the electrical wire and not by the handle.

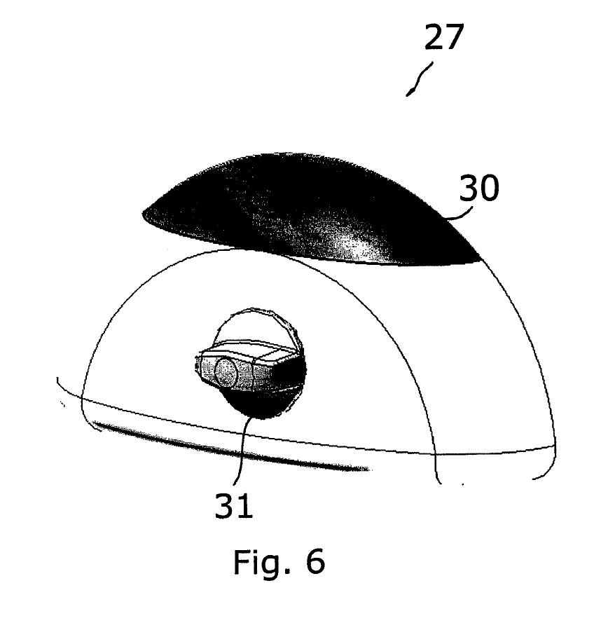

FIG. 6 shows an enlarged view of the unit 27 with the lamp 30 and the handle 31 in which the temperature sensing structure is located.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A system adapted to modify a temperature of a space based on a user selected set-point for the temperature of the space, the system comprising:
a climate modifying structure for modifying the temperature of the space,
a temperature sensing structure for providing a temperature signal significant for the temperature of the space,
a control structure comprising a base and a handle and being adapted for setting the set-point by movement of the handle relative to the base, and
processing means arranged:
in communication with the control structure to receive a set point signal significant for the set-point,
in communication with the temperature sensing structure to receive the temperature signal, and
in communication with the climate modifying structure to control modification of the temperature based on the set point and the temperature signal,
wherein the temperature sensing structure is comprised in the handle.

2. The system according to claim 1, wherein the handle is located in the space and the processing means is located outside the space.

3. The system according to claim 1, wherein the base is located outside the space, and the handle projects from the base through a wall which encapsulates the space and into the space.

4. The system according to claim 1, wherein the control structure comprising oblong electrical conductive legs one of which defining a common ground potential for the set-point signal and for the temperature signal.

5. The system according to claim 4, wherein the conductive legs are received in a printed circuit board which forms part of the processing means.

6. The system according to claim 1, forming a refrigerator.

7. A control structure for setting a set point of a temperature of a space in which the control structure is located, the control structure comprising a base and a handle and being adapted for setting the set-point by movement of the handle relative to the base, characterised in that the handle comprises a temperature sensing structure for providing a temperature signal significant for a temperature of the space.

8. The control structure according to claim 7, comprising an attachment structure for attaching the structure to a planar inliner of a refrigerator casing, the base being located on a first side of the attachment structure, and the handle projecting from the base to an opposite, second, side of the attachment structure.

9. The control structure according to claim 7, further comprising illuminating means adapted to project light through a portion of the handle.

10. The control structure according to claim 9, wherein the light is projected towards the second side of the attachment structure.
